(19) United States
(12) Patent Application Publication
(10) Pub. No.: US 2026/0022596 A1
(43) Pub. Date: Jan. 22, 2026

(54) Operating Mechanism for Operating a Vehicle Door

(71) Applicant: Illinois Tool Works Inc., Glenview, IL (US)

(72) Inventors: Erik Dilje, Würzburg (DE); Andreas Rudolf, Eibelstadt (DE)

(21) Appl. No.: 19/272,090

(22) Filed: Jul. 17, 2025

(30) Foreign Application Priority Data
Jul. 18, 2024 (DE) 10 2024 120 315.3

(51) Int. Cl. E05B 85/18; B60Q 1/26; E05B 81/76

(52) U.S. Cl. CPC E05B 85/18; B60Q 1/2669; E05B 81/76

(57) ABSTRACT

The disclosure relates to an actuating mechanism for operating a vehicle door, especially for unlocking, opening, or locking it. The mechanism includes an actuator, such as a handle, that allows the door to be opened manually, and a supporting structure. The key feature is that the actuator is mounted so it can pivot relative to the supporting structure around a pivot point. Part of the actuator is designed as a housing shell, and inside this shell is a sensor. The sensor is designed to produce an electrical signal when the actuator is used.

### RELATED APPLICATION

The present application claims the benefit of German Patent Application No. 10 2024120 315.3, filed Jul. 18, 2024, titled “Operating Mechanism for Operating a Vehicle Door,” the contents of which are hereby incorporated by reference.

### BACKGROUND

In particular in the automotive industry, doors and flaps are increasingly no longer opened and closed only manually, i.e., mechanically. Rather, the opening and closing movements, and in particular the unlocking of doors, are performed more frequently automatically, in particular electrically. For example, an electric motor is used here, which, when desired, drives a mechanism for locking and unlocking the doors and flaps. In order to generate a signal for opening and closing to such electric drives or the associated control apparatuses, a switch can be provided, which generates the desired signal by way of an actuation by the user. Such switches can be configured as push-buttons, which, when pressed in by the user, generate the aforementioned signal.

In addition to the release switches, pull handles are required in order to be able to pull open the doors open after unlocking. The handle and push-buttons are often difficult to reach with one hand movement, so that the unlocking and pulling open of doors must be done separately.

For the above-mentioned reasons, the problem addressed by the present disclosure is to specify an actuating mechanism for actuating vehicle doors, which can be used for unlocking and simultaneously opening the vehicle door in a single movement.

### SUMMARY

The present disclosure relates generally to an actuating mechanism, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically and in an isometric view, an exemplary embodiment of the actuating mechanism according to the disclosure in its intended use.

FIG. 2 illustrates schematically and in a cross-sectional view, the exemplary embodiment of the actuating mechanism according to the disclosure according to FIG. 1.

FIG. 3 illustrates schematically and in an isometric view, an exemplary embodiment details of the exemplary embodiment of the biasing element associated with the actuator of the exemplary embodiment of the actuating mechanism according to the disclosure, which is configured as a bi-directional spring element and enables tolerance compensation.

FIG. 4A illustrates the mode of operation of the biasing element associated with the actuator of the exemplary embodiment of the actuating mechanism according to the disclosure, as shown in FIG. 3.

FIG. 4B illustrates the functioning of the biasing element associated with the actuator of the exemplary embodiment of the actuating mechanism according to the disclosure, as shown in FIG. 3.

FIG. 5 illustrates schematically and in an isometric view, a further exemplary embodiment of the actuating mechanism according to the disclosure without the actuator designed as a housing shell.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to an actuating mechanism for actuating a vehicle door, in particular for unlocking and opening a vehicle door. The disclosure also relates to a vehicle with a corresponding actuating mechanism for unlocking and opening a vehicle door.

Accordingly, the disclosure relates in particular to an actuating mechanism for actuating, in particular unlocking and opening, a vehicle door, wherein the actuating mechanism comprises an actuator and a bearing structure. The actuator is in particular an actuator having a handle or a handle wherein the actuator is generally suitable for opening a vehicle door.

The actuator is mounted relative to the bearing structure to be pivotable about a pivot axis, in particular on the bearing structure. The pivot axis preferably passes parallel to the longitudinal axis of the vehicle, although other configurations are also conceivable.

According to the disclosure, it is provided in particular that the actuator is configured at least in part or in sections as a housing shell, in the interior of which a sensor apparatus is arranged or accommodated at least in part or in sections, which is configured to generate an electrical signal when the actuator is actuated.

The advantages of the present disclosure are obvious: particularly the actuator can be configured to be particularly small and simple, because it is only used in order to grasp the actuating mechanism. A signal for unlocking the vehicle door can be generated, for example, by the sensor apparatus, which is accommodated at least in part or in sections in the interior of the actuator designed as a housing shell.

The pivoting range by which the actuator can be pivoted relative to the bearing structure about the pivot axis is preferably a maximum of 50 degrees, preferably a maximum of 30 degrees, and even more preferably a maximum of 15 degrees. As a relatively small swivel range is permitted for the actuator, it can also be used to pull the vehicle door open after unlocking.

The actuating mechanism in particular performs a dual function, which can be implemented with only one hand movement. In particular, by moving, in particular pulling, the actuator, an unlocking of the vehicle door can be achieved via the sensor apparatus, on the one hand. On the other hand, the pulling on the actuator can be used in order to simultaneously pull open the vehicle door. It is therefore not necessary to first provide a button for unlocking the vehicle door in addition to an actuating element for pulling open the vehicle door.

According to preferred embodiments of the actuating mechanism according to the disclosure, it is provided that the bearing structure has a carrier which, in the intended use of the actuating mechanism, projects outwardly from the outer skin or outer body of the vehicle and on which the sensor apparatus is arranged or received. The carrier projecting outwardly from the outer skin or outer body of the vehicle may be an integral part of the bearing structure; however, it is also conceivable that the carrier projecting outwardly from the outer skin or outer body of the vehicle is a separate component of the bearing structure.

In particular, in connection with the latter preferred embodiment of the actuating mechanism according to the disclosure, the actuation means may be designed, at least in part or in sections, as a housing with an upper housing shell and a lower housing shell. In particular, it is provided that at least the carrier projecting outwardly from the outer skin or outer body of the vehicle is accommodated at least in part or in sections between the upper housing shell and the lower housing shell.

Preferably, the bearing structure and, in particular, the carrier projecting outwardly from the outer skin or outer body of the vehicle is fixed relative to the vehicle body.

According to further developments of the last-mentioned embodiment of the actuating mechanism according to the disclosure, it is provided that the upper housing shell and the lower housing shell are each designed as separate components which are connected or can be connected to one another in a detachable manner, in particular by means of a positive-locking connection.

This embodiment allows particularly easy removal and installation of the actuator.

With regard to the sensor apparatus, according to embodiments of the actuating mechanism according to the disclosure, it is provided that this has at least one switch, in particular a microswitch and preferably a capacitive or inductive switch, which can be actuated in particular via a switch tappet connected or connectable to the actuator.

In preferred embodiments, the switch is configured as an MOC switch.

However, the sensor apparatus is not limited to having at least one switch, in particular a microswitch and/or MOC switch. It is particularly conceivable that the sensor apparatus further comprises at least one radar sensor and/or at least one IR sensor, which is arranged or mounted on the bearing structure and in particular on the carrier of the bearing structure projecting outwards from the outer skin or outer body of the vehicle.

According to embodiments of the actuating mechanism according to the disclosure, a data transmission device based on RFID technology, in particular an NFC data transmission device, is preferably accommodated within the actuator designed as a housing shell. This allows, in particular, Bluetooth or WLAN authentication data of the user to be transmitted.

Alternatively, or in addition to this, it is conceivable that at least one light source is accommodated in the actuator designed as a housing shell. The light source can in particular be arranged or accommodated on the bearing structure and preferably on the carrier of the bearing structure projecting outwards from the outer skin or outer body of the vehicle.

The actuator serving as a handle is mounted relative to the bearing structure in such a manner that manipulation of the actuator causes the actuator to pivot about the pivot axis. The sensor apparatus is configured in particular to capture movement of the actuator relative to the bearing structure.

According to a further aspect of the disclosure, the actuator is assigned at least one biasing element for biasing the actuator into a first pivot position relative to the bearing structure.

According to embodiments of the latter design, it is envisaged that the at least one biasing element is configured as a two-way spring element, and in particular as a double-wound torsion spring.

Alternatively, or in addition to this, the at least one biasing element is configured as a bi-directional spring element with tolerance compensation. The bidirectionally acting spring element preferably has a first spring leg and a second spring leg, wherein the first spring leg has an additional degree of elasticity for tolerance compensation, so that an alignment of the actuator relative to the bearing structure is affected at the first spring leg.

The disclosure also relates to a vehicle with a vehicle outer skin or vehicle outer body and an actuating mechanism described above, wherein the bearing structure of the actuating mechanism serves to securely connect the actuating mechanism to the vehicle body and at the same time to transmit a force via the actuator to the vehicle door.

The actuator is preferably arranged on an A, B, or C pillar of the vehicle.

Exemplary embodiments of the actuating mechanism according to the disclosure are described in more detail below with reference to the accompanying drawings.

The actuating mechanism as defined in the accompanying patent claims is specified in more detail in the accompanying drawings using exemplary embodiments.

The actuating mechanism 1 according to the disclosure, as shown in various embodiments in the drawings, is characterized in particular by the fact that it has an actuator 3, in particular with a handle, and a bearing structure 4. The actuator 3 is preferably designed as a handle or handle area.

In particular, the actuator 3 is configured as a movable shell around the bearing structure 4 serving as the functional core of the actuating mechanism 1.

It is provided that the actuator 3 is mounted relative to the bearing structure 4 to be pivotable about a pivot axis 5, in particular on the bearing structure 4. The actuator 3 is configured at least in part or in sections as a housing shell or as housing shells 9, 10, in the interior of which a sensor apparatus 6 is arranged or received at least in part or in sections as a functional core, which is configured to generate an electrical signal when the actuator 3 is actuated.

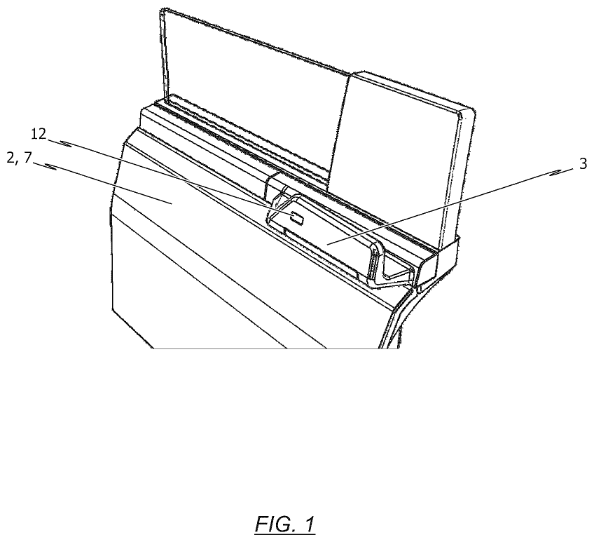

In the exemplary embodiment of the actuating mechanism 1 according to the disclosure shown in isometric view in FIG. 1, the actuator 3 is configured as an outer door handle in wing form. Pulling or pushing the actuator 3 designed as a door handle produces a small rotary movement and, via the sensor system (sensor apparatus 6) accommodated in the interior of the actuator 3, an electrical signal for unlocking/locking the vehicle door 2.

In particular, in the exemplary embodiment of the actuating mechanism 1 shown in FIG. 1 of the exemplary embodiment of the actuating mechanism 1 according to the disclosure, the bearing structure 4 has a carrier 8 which, in the intended use of the actuating mechanism 1, projects outwards from the outer skin or outer body of the vehicle and on which the sensor apparatus 6 is arranged or received.

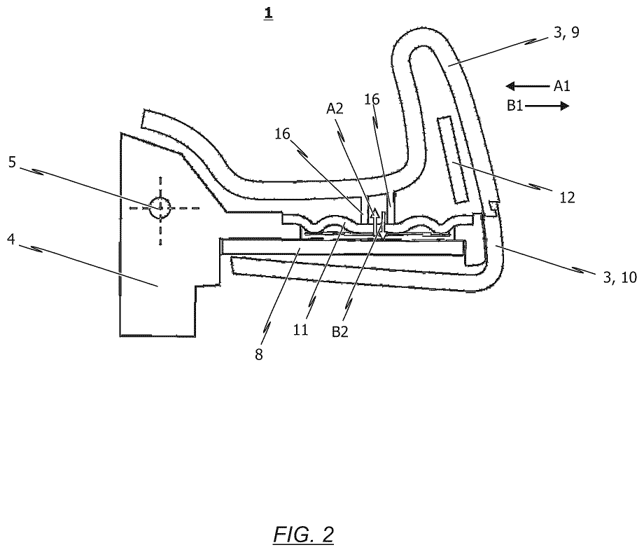

This can be seen from the schematic sectional view according to FIG. 2.

The sectional view according to FIG. 2 also shows that the actuator 3 is configured at least in part or in sections as a housing with an upper housing shell 9 and a lower housing shell 10. At least the carrier 8 projecting outwardly from the outer skin or outer body 7 of the vehicle is accommodated at least in part or in sections between the upper housing shell 9 and the lower housing shell 10.

Preferably, the upper housing shell 9 and the lower housing shell 10 are each designed as separate components which are connected or can be connected to one another in a detachable manner, in particular by means of a positive-locking connection.

The actuator 3 is pivotably mounted on the pivot point 5. By pressing the actuating device 3 from the outside, as indicated by arrow Al in FIG. 2, an actuating area or switch tappet 16 of the actuator 3 is moved upwards by the bearing structure 4 and the sensor system (sensor apparatus 6) arranged on the carrier 8 due to the rotary bearing of the actuator 3 (see arrow A2). This generates a door locking signal.

If, on the other hand, a pulling movement acts on the actuator 3 (see arrow B1), the actuating area or switch tappet 16 of the actuator 3 is moved in the direction of the bearing structure 4 or in the direction of the carrier 8, as a result of which the sensor system (sensor apparatus 6) arranged on the bearing structure 4 generates a signal for opening the vehicle door 2 or for unlocking the vehicle door 2.

In particular, as indicated in FIG. 2, the sensor apparatus 6 of the actuating mechanism 1 is arranged or mounted on the bearing structure 4 and, in particular, on the carrier 8 projecting outwardly from the outer skin or outer body 7 of the vehicle.

This may be a printed circuit board with a corresponding sensor technology. The sensor system or sensor apparatus 6 thus has at least one switch, in particular a microswitch and preferably a capacitive or inductive switch, which can be actuated in particular via the actuating area 16 connected to the actuator 3, which serves as a switch tappet. The switch is preferably designed as an MOC switch.

As can also be seen from FIG. 2, it is conceivable that the sensor apparatus 6 of the actuating mechanism 1 further comprises at least one NFC data transmission device 12, which is preferably accommodated in the interior of the actuator 3 designed as a housing shell.

The NFC data transmission device 12 must be located outside the metal structure of the vehicle door 2.

It is also conceivable that the actuating mechanism 1 has at least one light source, which is preferably also accommodated in the interior of the actuator 3 designed as a housing shell and, in particular, is arranged or accommodated on the bearing structure 4 and, in particular, on the carrier 8 of the bearing structure 4 projecting outwards from the outer skin or outer body 7 of the vehicle. The lighting integrated in the actuating mechanism 1 has the advantage that a compact light guide is formed by the actuating mechanism 1 and in particular by the actuator 3.

Although not shown in the drawings, it is also conceivable that a radar device is also arranged in the interior of the actuator 3, which is configured as a housing shell.

In particular, the solution according to the disclosure does not provide for the MOC switch of the sensor apparatus 6 to be mounted on a secondary printed circuit board in the lower part of the carrier 8, as is often the case with known solutions. This would require the moving part, i.e., the actuator 3, to protrude in the direction of the MOC switch, resulting in a complicated mechanism.

Rather, the solution according to the disclosure provides for the entire sensor system to be integrated in the actuator 3, which is configured as a housing shell, which considerably simplifies the mechanics for actuating the MOC switch in particular. In addition, the wiring effort is also significantly reduced.

A further aspect of the present disclosure is to be seen in the bidirectionally operating spring element 13 with tolerance compensation.

In particular, at least one biasing element is assigned to the actuator 3 as a spring element 13 in order to bias the actuator 3 into a first pivot position relative to the bearing structure 4.

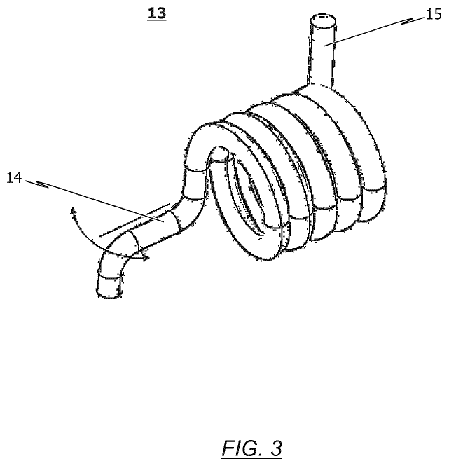

As shown in FIG. 3, the biasing element is configured as a two-way spring element 13, and in particular as a double-wound torsion spring. In particular, the biasing element serves as a bi-directional spring element 13 with tolerance compensation.

For this purpose, the bidirectionally acting spring element 13 has a first spring leg 14 and a second spring leg 15, wherein the first spring leg 14 has an additional degree of elasticity for tolerance compensation, so that an alignment of the actuator 3 relative to the bearing structure 4 is affected at the first spring leg 14.

Instead of (multiple) biasing elements, in particular springs, which act in both directions and define a nominal position, the solution according to the disclosure uses only a single, bi-directional spring element 13 as a biasing element.

With two spring elements acting in both directions and defining the nominal position, the two spring legs of each spring element must be in contact with both movement partners (actuator 3 and bearing structure 4). This has the disadvantage that, in such a system, free play is difficult to avoid.

By using instead, a single, but bi-directional spring element 13, i.e., a single spring with an additional degree of elasticity at one of the spring legs 14, 15, the spring element 13 also compensates for deviations between the actuator 3 and the bearing structure 4.

The additional (second) degree of elasticity of the spring element 13 acts with a lower force. This achieves alignment between the actuator 3 and the bearing structure 4 at the first spring leg 14.

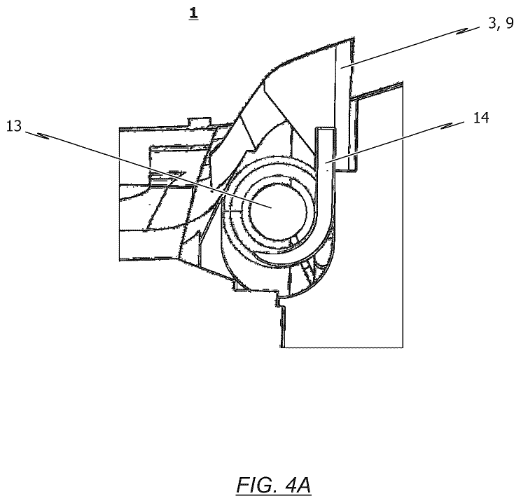

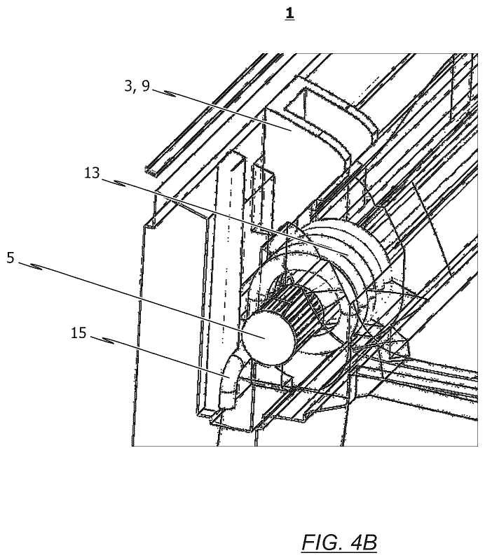

This is shown in detail in FIG. 4A and FIG. 4B.

In FIG. 4A, the first spring leg 14 of the bidirectionally acting spring element 13 aligns the actuator 3 as a movable part with the bearing structure 4 or the handle carrier as an inert part.

In FIG. 4B, it is indicated that the second spring leg 15 of the bi-directional spring element 13 always comes into contact with the movable part and the inert part, even if they are not aligned with each other. This effectively prevents free play and thus provides a simple and effective means of compensating for tolerance.

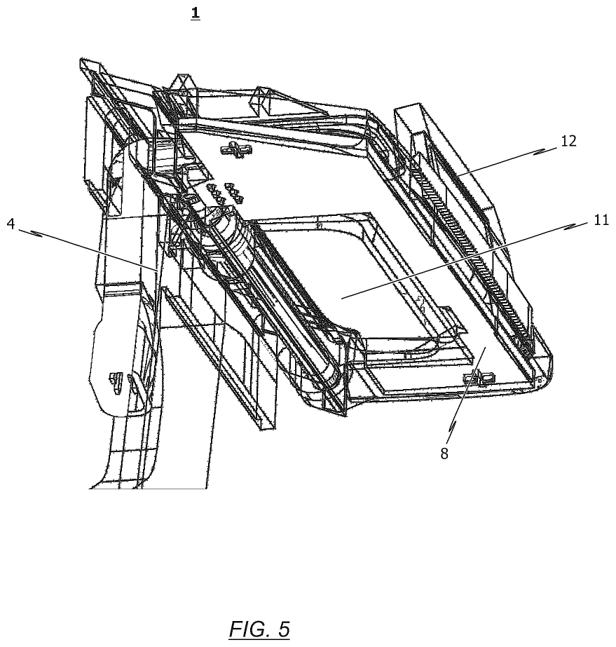

FIG. 5 shows details of an exemplary embodiment of the actuating mechanism 1 according to the disclosure without the actuator 3 designed as a housing shell.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Actuating mechanism
2 Vehicle door
3 Actuator/handle
4 Bearing structure
5 Pivot axis
6 Sensor apparatus
7 Outer skin/outer body
8 Carrier
9 Upper housing shell
10 Lower housing shell
11 Microswitch/MOC Switch
12 NFC data transmission device
13 Biasing element/spring element
14 First spring leg
15 Second spring leg
16 Actuating area/switch tappet

What is claimed is:

1. An actuating mechanism (1) for actuating, in particular unlocking and opening or locking, a vehicle door (2), wherein the actuating mechanism (1) has the following:
an actuator (3) for opening the vehicle door (2) manually, and
a bearing structure (4),
wherein the actuator (3) is pivotably mounted relative to the bearing structure (4) about a pivot axis (5) on the bearing structure (4), and
wherein the actuator (3) is configured in part or in sections as a housing shell, in the interior of which a sensor device (6) is arranged or accommodated at least in part or in sections, which sensor apparatus is configured to generate an electrical signal when the actuator (3) is actuated.

2. The actuating mechanism (1) according to claim 1,
wherein the bearing structure (4) has a carrier (8) which, in the intended use of the actuating mechanism (1), projects outwardly from the outer skin or outer body (7) of the vehicle and on which the sensor apparatus (6) is arranged or received.

3. The actuating mechanism (1) according to claim 2,
wherein the actuator (3) is configured at least in part or in sections as a housing with an upper housing shell (9) and a lower housing shell (10), and
wherein at least the carrier (8) projecting outwardly from the outer skin or outer body (7) of the vehicle is received at least in part or in sections between the upper housing shell (9) and the lower housing shell (10).

4. The actuating mechanism (1) according to claim 3,
wherein the upper housing shell (9) and the lower housing shell (10) are each designed as separate components which are connected or can be connected to one another in a detachable manner via a positive-locking connection.

5. The actuating mechanism (1) according to claim 1,
wherein the sensor apparatus (6) is arranged or received on the bearing structure (4) and on the carrier (8) projecting outwardly from the outer skin or outer body (7) of the vehicle.

6. The actuating mechanism (1) according to claim 1,
wherein the sensor apparatus (6) has at least one switch (11) that can be actuated via a switch tappet (16) connected to the actuator (3).

7. The actuating mechanism (1) according to claim 6,
wherein the switch (11) is configured as an MOC switch.

8. The actuating mechanism (1) according to claim 1,
wherein the sensor apparatus (6) further comprises at least one radar sensor and/or at least one IR sensor, which is accommodated in the interior of the actuator (3) configured as a housing shell and is arranged in particular on the bearing structure (4) and on the carrier (8) of the bearing structure (4) projecting outwards from the outer skin or outer body (7) of the vehicle.

9. The actuating mechanism (1) according to claim 1,
wherein the sensor apparatus (6) further comprises at least one NFC data transmission device (12) that is accommodated in the interior of the actuator (3) configured as a housing shell.

10. The actuating mechanism (1) according to claim 1,
wherein the actuating mechanism (1) comprises at least one light source which is accommodated in the interior of the actuator (3), configured as a housing shell, and which is arranged or accommodated in particular on the bearing structure (4) and, in particular, on the carrier (8) of the bearing structure (4) projecting outwards from the outer skin or outer body (7) of the vehicle.

11. The actuating mechanism (1) according to claim 1,
wherein the actuator (3) is mounted movably relative to the bearing structure (4) such that manipulation of the actuator (3) causes the actuator (3) to pivot, wherein the sensor apparatus (6) is configured to capture movement of the actuator (3) relative to the bearing structure (4).

12. An actuating mechanism (1) according to claim 1 or according to the preamble of claim 1,
wherein a biasing element (13) is assigned to the actuator (3) for biasing the actuator (3) into a first pivot position relative to the bearing structure (4).

13. The actuating mechanism (1) according to claim 12,
wherein the at least one biasing element (13) is configured as a two-way spring element.

14. The actuating mechanism (1) according to claim 12,
wherein the at least one biasing element (13) is configured as a bi-directional spring element with tolerance compensation.

15. The actuating mechanism (1) according to claim 14,
wherein the bi-directional spring element has a first spring leg (14) and a second spring leg (15), wherein the first spring leg (14) has an additional degree of elasticity for tolerance compensation, so that an alignment of the actuator (3) relative to the bearing structure (4) is affected on the first spring leg (14).

16. The actuating mechanism (1) according to claim 6,
where the at least one switch (11) is a microswitch.

17. The actuating mechanism (1) according to claim 6,
where the at least one switch (11) is a capacitive switch or an inductive switch.

18. The actuating mechanism (1) according to claim 12,
wherein the at least one biasing element (13) is configured as a double-wound torsion spring.
